(19) United States
(12) Patent Application Publication
(10) Pub. No.: US 2008/0072113 A1
(43) Pub. Date: Mar. 20, 2008

(54) Method of locating packet for resend from retry buffer

(76) Inventors: Siukwin Tsang, Daly City, CA (US); Mitrajit Chatterjee, San Jose, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/514,281

(22) Filed: Aug. 30, 2006

(51) Int. Cl. H04L 1/18; G08C 25/02

(52) U.S. Cl. 714/748

(57) ABSTRACT

In PCI-Express and alike network systems, back-up copies of recently sent packets are kept in a retry buffer for resending if the original packet is not well received by an intended destination device. A method for locating the back-up copy in the retry buffer comprises applying a less significant portion of the sequence number of a to-be-retrieved back-up copy to an index table to obtain a start address or other locater indicating where in the retry buffer the to-be-retrieved back-up copy resides.

### FIELD OF DISCLOSURE

The present disclosure of invention relates generally to network systems that transmit information in packet format. The disclosure relates more specifically to systems that resend packets from a retry buffer when an initial transmission of a packet fails to reach a desired destination intact.

### DESCRIPTION OF RELATED ART

Use of digitally-encoded packets in data communication systems is well known. Typically each packet is layered like an onion to have header-type outer shell sections, a payload or message core section and one or more error correction sections that cover various parts of the core or outer shells. Packets may be transmitted individually or as parts of relatively continuous streams or bursts depending on quality of service requirements and/or availability of transmission links. When packet signals are transmitted from a source device to a receiving device, the packet signals that arrive at the receiving device typically progress through a physical interface layer (PL), and then through one or both of a data link layer (DL) and a transaction layer (TL). The physical interface layer (PL) may include means for serializing and deserializing data (SERDES) and means for recognizing the start and end of each ingressing packet. The data link layer (DL) may include means for managing error checking, error correction (e.g., ECC, CRC) and/or managing packet ordering and verifying completion of sequences of interrelated packets. The transaction layer (TL) may include means for parsing (peeling the onion skin layers of) different parts of each kind of post-DL packet so as to get to desired portions of the payload data or message data for respective processing. Specific processing TL output data may be carried out by a so-called, File Data Processing Layer. Before it is sent to the File Data Processing Layer, payload and/or message data from sequentially ingressing packets may sometimes need to be reordered for purposes of reconstructing an original data sequence different from the ingress sequence, where the original data sequence may, for example, be required for reconstituting a rasterized graphic image. To this end, unique sequence numbers are often embedded in successive ones of ingressing or egressing packets so that desired ordering of data can be achieved in the receiving device.

Packet signals leaving a source device typically progress in the reverse order, namely, first by moving outgoing payload data from the file layer and through the transaction layer (TL) for attachment of transaction control code, then through the data link layer (DL) for attachment of sequence number code and error check code thereto, and finally through the sender's physical interface layer (PL) for encoding into a serial transmission format and output onto a physical transmission media (e.g., a high frequency cable or printed circuit strip or wireless transmission in some cases).

Because an output packet may fail to reach its targeted destination intact for any of a number of reasons (i.e., noise induced error), a backup copy of each egressing packet is often temporarily stored in a retry buffer (RB) of the source device for a short while. If the destination device sends a retry request and/or fails to timely acknowledge receipt, the backup copy is resent from the retry buffer.

One problem associated with resending the backup copy from the retry buffer is that of identifying and locating the correct packet that is to be resent from the retry buffer. A variety of complex schemes may be devised. The present disclosure provides an elegantly simple way of identifying and locating the correct packet to be resent.

### SUMMARY

A packets outputting device in accordance with the present disclosure includes a retry buffer for storing egressing and resendable packets in respective storage locations of the retry buffer and an index table for tracking the respective storage locations of the resendable packets, where the packet storage locations are sorted according to unique sequence numbers assigned to the egressing and resendable packets. When a retry request arrives (e.g., in the form of a negative acknowledge—a NAK), the retry request contains the sequence number of the packet that is to be resent. A less significant subset of bits forming the sequence number in the retry request is used to define an index into the index table. The correct fetch address or other locater for the desired packet is stored at the indexed location in the index table. This fetch locater is output from the index table and applied to the retry buffer to locate and fetch the correct packet from the retry buffer. When backup copies of packets are stored in the retry buffer, the corresponding storage locaters for the respective packets are stored in the index table according to the sequence numbers of the stored packets.

In one embodiment, the retry buffer operates somewhat like a FIFO that stores the last 16 packets sent out. The index table also operates somewhat like a FIFO that stores the respective start addresses of the last 16 packets in the retry buffer. The 16 start addresses are accessible (i.e., CAM style) according to the corresponding, least significant four bits of the sequence numbers used by the last 16 payload-containing packets that were sent out. When a retry request is received, the least significant four bits of the sequence number in the retry request are used to form the address signal applied to the index table. In response, the index table outputs the correct fetch address for the desired packet whose contents are stored in the retry buffer and are to be resent.

A retry packet storing method in accordance with the disclosure comprises: (a) using at least part of a sequence number of a packet to be stored in a retry buffer for generating an index into an index table; (b) storing the packet in the retry buffer at a start address assigned to the packet; and (c) recording the start address for the packet (or another locater of the packet) in the index table according to the generated index.

A retry packet fetching method in accordance with the disclosure comprises: (a) using at least part of a sequence number of a packet to be fetched from a retry buffer for generating an index into an index table; (b) obtaining a locater (e.g., fetch address) for the to-be-fetched packet from the index table according to the generated index; and (c) fetching the packet from the retry buffer according to the locater obtained from the index table.

A retry buffer managing system in accordance with the disclosure comprises: (a) an index table for storing locaters (e.g., fetch addresses) of to-be-fetched packets stored in a retry buffer; (b) an index generator coupled to the index table for generating indexes into the index table, where the index generator is at least responsive to sequence numbers associated with packets to be stored or fetched from the retry buffer; and (c) a retry buffer operatively coupled to the index table so as to receive read start addresses from the index table (or other forms of locaters) where the read start addresses (or corresponding locaters) are stored in the index table according to said indexes generated by the index generator. One embodiment of the retry buffer managing system further includes a validity checker for testing validity of sequence numbers applied to the index generator when fetching packets from the retry buffer. The validity testing includes a determining of whether supplied sequence numbers are in a range between the sequence number of a last-received Ack or NAK and the sequence number of a last-sent payload-carrying packet inclusively.

Other aspects of the disclosure will become apparent from the below detailed description.

### BRIEF DESCRIPTION OF THE DRAWINGS

The below detailed description section makes reference to the accompanying drawings, in which:

FIG. 1 is a block diagram showing a packet switching system having retry buffers (RB) for temporarily storing post-process packets that are being dispatched via respective egress links and may have to be resent;

FIG. 2 is a schematic diagram showing the structure of a PCI-Express packet that contains a relatively unique sequence number associated with its payload portion of a sequence of payloads being delivered to a destination device; and

FIG. 3 is schematic diagram showing an index table coupled to a retry buffer in accordance with the disclosure.

### DETAILED DESCRIPTION

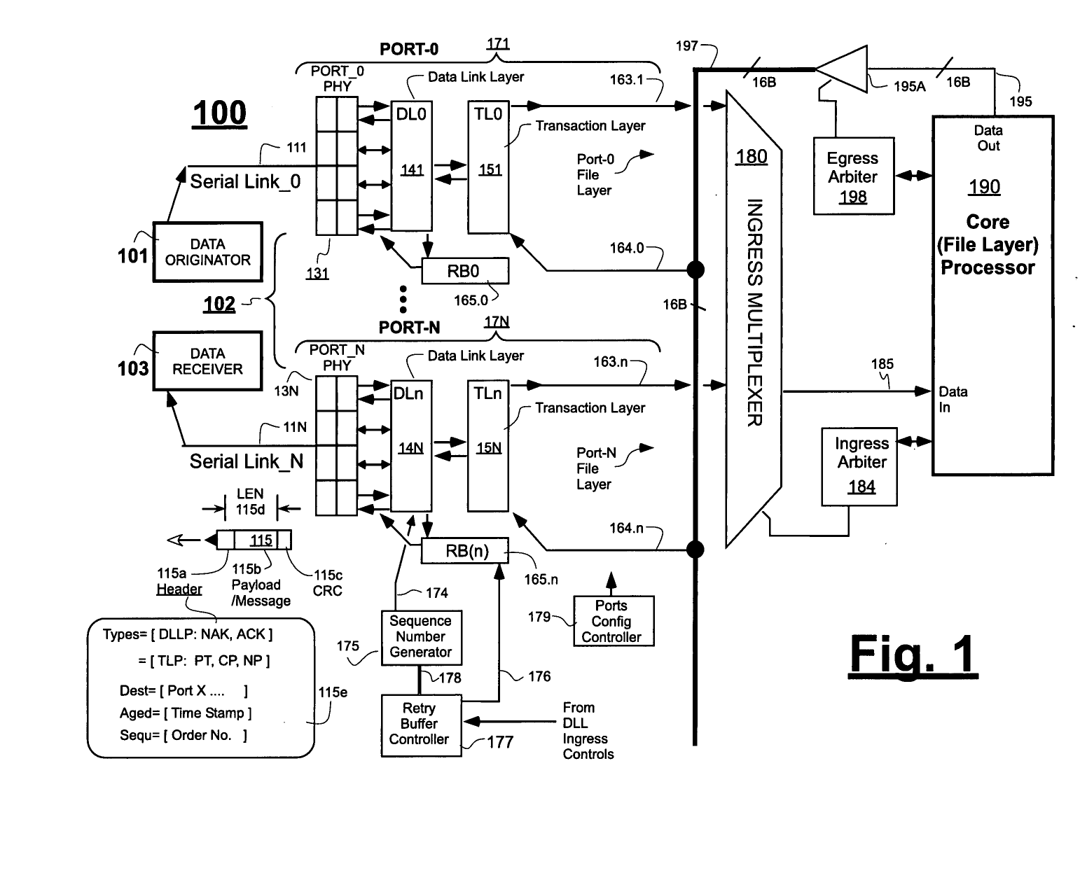

Referring to FIG. 1, shown is a system 100 that uses a PCI-express™ serial interconnect network to interconnect a data originating, first device 101 (Originator) to a data receiving, third device 103 (Receiver) by way of a data routing and/or processing second device 102. Each of devices 101-103 may be implemented as a monolithic integrated circuit (IC). Although the second device 102 is shown in greater detail as constituting a multiported packet routing one and as being used for implementing an in-network switching unit, the second device 102 alternatively could have been a single ported one such as for implementing an endpoint device (e.g., a data storage unit) in the switched packet network.

In the illustration, a multiplexed first serial physical link such as 111 couples the first device 101 (Data Originator) to a physical layer interface 131 of the second device 102. (The schematically illustrated, serial link 111 is merely conceptual and may be implemented by use of plural serial links, i.e., plural twisted wire couplings, rather than just one link. It may include use of optical media as well as electrical media.) Multiple channels of data may be transmitted over the first multiplexed serial physical link 111 by use of one or more forms of signal multiplexing. Time domain multiplexing (TDM) may be used for example, on the physical serial link 111 for mixing together the data of a number of sub-channels or “lanes” of data as they are called in PCI-express so as to define an aggregated logical channel of data flowing into a corresponding logical “port” or PCI-Express logical “link” 171 formed in second device 102.

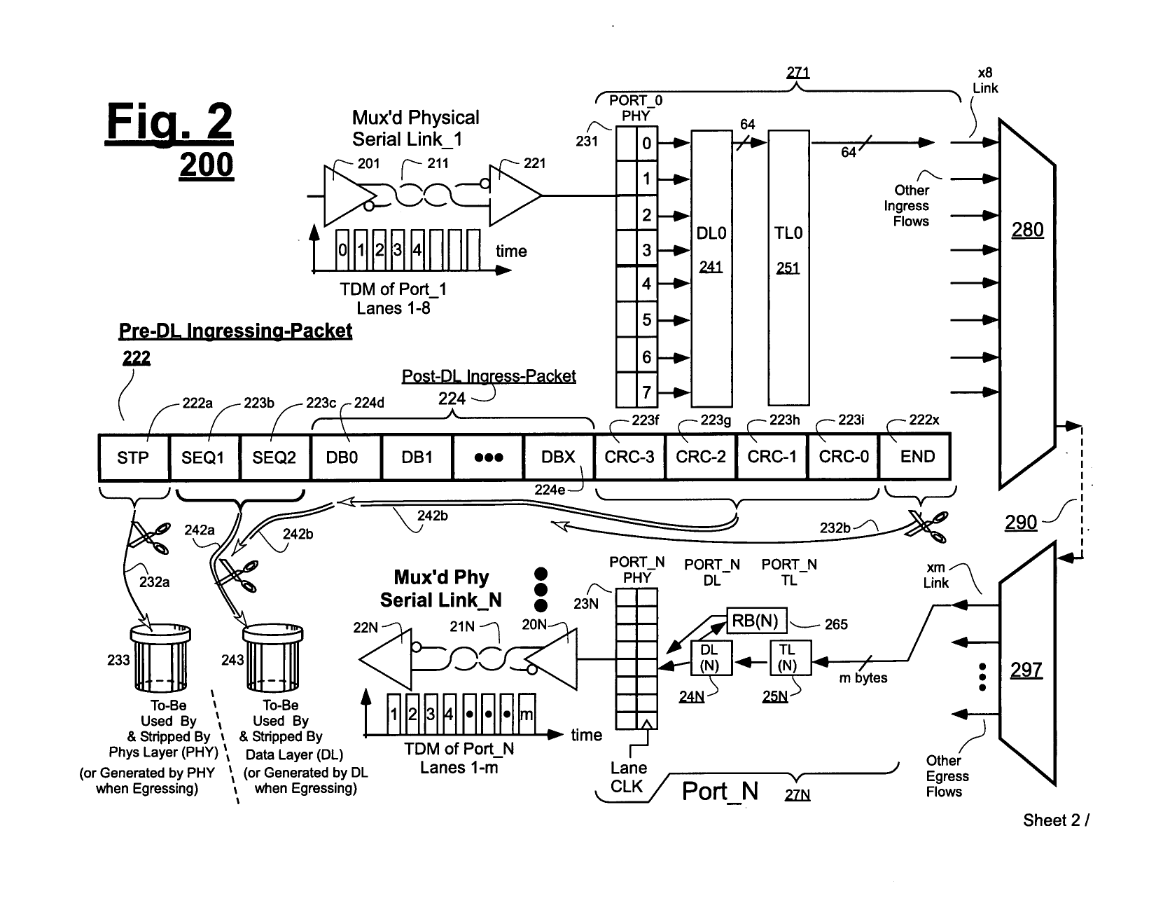

In the illustrated example, system configuration operations have created an aggregation of four lanes numbered 0-3 for PCI port 171, with each lane effectively constituting a one byte (1-B) wide parallel lane after SERDES operations are performed in the physical layer. The physical layer interface portion 131 (PHY) of port 171 (which port is also identified as PORT_0) receives the serially transmitted signals of multiplexed link 111 (e.g., a differential and optically encoded signal; i.e., 10 bits per character optical encoding) and converts the received, serial data into four parallel data flows of 8 bit encoded data that combine and flow into a respective Port-0 Data Link layer 141 in step with a corresponding lane synchronizing clock (not shown, see FIG. 2). After processing by the Data Link layer 141, remaining packet bytes are next processed by the transaction layer 151 of that Port_0 (171) and subsequently remaining packet bytes are thereafter processed by a core payload processor 190 (sometimes referred to as the File Data Layer Processor). In one embodiment, the core payload processor 190 provides port-to-port routing of payload data. Egressing payload data then passes out through a routing-defined, egress port_N (17N) and through its respective TL, DL and PHY layers prior to continuing on serial link 11N to the destination device 103.

The present disclosure will be focusing on so-called retry buffers, RB0-RB(N) in the respective m-lane ports (where m can be a different integer such as 1, 2, 4, 8, 16 for each of the reconfigurable ports). Although PCI-Express is used as an example here, similar retry buffer structures may be employed in other packet processing systems and similar techniques for managing the retry buffer structures may be employed if practical in cases where packets are filled with unique sequence numbers and the resend request includes at least part of the sequence number of the packet that is to be resent from the retry buffer.

Before continuing with further details of FIG. 1, some background on PCI-Express may be in order at this point, particularly as it applies to port management. The more standard, PCI bus is a well known form of standardized signal interchange within the field of digital computer and communication system design. One lesser known extension of the PCI bus standard is referred to as PCI-X. An emerging, but not as yet, well known extension of these is referred to as PCI-Express. The three should not be confused with one another. While the present disclosure focuses on a first generation of the PCI-Express protocol, design of a second generation, PCI-Express 2.0 protocol is in development and it is expected that the present disclosure will also be applicable to PCI-Express 2.0 as well as later generations.

PCI-Express 1.0 may be characterized by its use of high speed serial links and of packets structured to move through such high speed serial links. Like other communication standards, the PCI-Express protocol has a layered architecture that includes (1) a Physical signaling layer, (2) a Data link layer and (3) a Transaction layer. The Physical signaling layer of PCI-Express is typically characterized by use of a Low-Voltage Differential Signaling (LVDS) high-speed serial interface specified for 2.5 GHz or higher signaling per lane, while further using 8B/10B or like link encoding and using AC-coupled differential signaling. A complementary set of LVDS pairs is sometimes referred to as a physical link. The PCI-Express standard allows for re-configurable lane combinations within each port so as to thereby form different numbers of wider (faster) or narrower (slower) communication ports designated as x1, x2, x4 and so on up to x32; where the x1 configuration of a given port is the slowest (narrowest) and the x32 configuration is the fastest (widest). Multi-lane links can provide for higher bandwidth communication capabilities than can a comparable single-width link that has long dead times. The Data link layer of the PCI-Express protocol is typically characterized by packet exchange standards that govern how packets route between neighboring PCI-Express entities and over its single or multi-lane highways while assuring data integrity and providing for sequence checking, along with packet acknowledgments and flow control. The Transaction layer of the PCI-Express protocol is typically characterized by standardized rules for translating data read and/or write requests as they move through switching nodes between an intelligent host and one or more endpoint devices. Design of the File Data processing layer is left to the end user's discretion.

There is much to the PCI-Express standard that is beyond the scope of the present disclosure. More information about the standard may be obtained via the internet from the PCI Special Interest Group at: http://www.pcisig.com/specifications.

Returning now to the specifics of FIG. 1, in this example, TL processed data words (e.g., bytes) may be temporarily stored in respective file data storage units or data stacks (not shown) within the core processor 190. In one embodiment, ingress-directed data (163.0-163.n) from the transaction layer sections 151-15N feeds into an ingress multiplexer 180. An ingress arbiter 184 determines when and which data will flow into the core processor 190. After processing in the core payload processing unit 190, post-process data moves out over a 16-Byte wide tristate bus 197 (in the illustrated embodiment) and selectively latches into respective egress capture registers at receiving ends of the TL units 151-15N. A small 4-bit bus (not shown) carries a port code which determines which of up to 16 ports will latch the post-process data currently on dispatch bus 197. This particular embodiment allows for a maximum of 16 one-lane ports or two by-8 ports. In other embodiments, bus 197 may be wider or narrower depending on port aggregation limitations. Egressing post-process data then moves from its respective transaction layer unit (151-15N) to the corresponding data link layer unit (141-14N); after which the data is passed into the physical layer unit 131-13N for serialization and output via a respective destination link as the illustrated 11N. At the same time that the DL block (e.g., 14N) attaches its data-link control bytes to the passing through packets of information and as it forwards the so re-packaged packet data to the physical layer (e.g., 13N), it also sends the re-packaged packet data to the corresponding retry buffer (e.g., RB(N) 165.n) for temporary storage therein in as a resendable copy of the egressing packet. If a resend request is received (e.g., a negative acknowledge from the link partner 103), the corresponding resendable copy in the retry buffer may be used to resend the requested packet. The resendable copy is fetched from the retry buffer and passed into the physical layer (e.g., 13N) for repeated transmission to the device (e.g., link partner 103) that made the resend request (or failed to provide a timely acknowledgement).

When large streams of packets are sent, every so often, the destination device 103 does not receive one of its expected packets or receives it in corrupted form (e.g., bad error check). In response to a corrupted receipt; the destination device 103 sends a resend request back through the data providing link 11N to the packet outputting device 102. Since the packet outputting device 102 keeps backup copies of the packets it recently sent in the corresponding retry buffer (i.e., 165.n), as already explained, the outputting device 102 does not need to tax its core processor 190 with locating and reprocessing of the pre-process data. The present disclosure focuses on methods for responding to resend requests, and more particularly on methods for locating the correct data in the responding retry buffers.

For purpose of completeness, FIG. 1 shows that ingress multiplexer 180 is controlled by the ingress arbiter 184. Dispatch bus driver 195A is controlled by an egress arbiter 198. The arbiters 184, 198 interface with the core processor 190. The ingress arbiter 184 indirectly interfaces With retry buffer controllers such as 177 for determining when a negative acknowledgement (NAK) is received and when retry data is to be responsively resent out through a respective link (e.g., 11N). Aggregation of lanes to form the various ports is controlled by a ports configuration controller 179. It determines, among other things, which retry buffer belongs to which port and what the configured capacity of the buffer should be in view of the variable number of lanes assigned to the port.

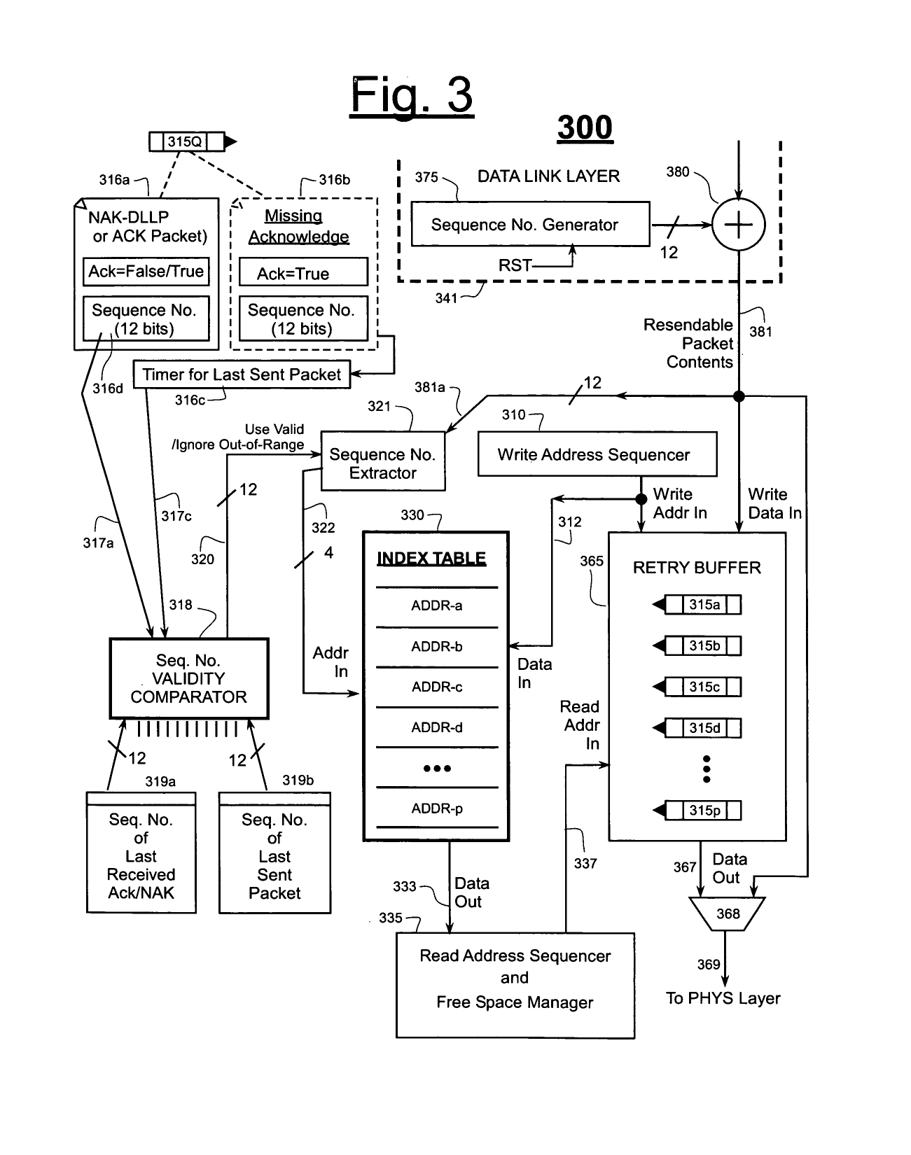

One of the functions that a PCI-Express data link layer unit (e.g., DL unit 14N) may perform is to attach sequence number bytes to egressing packet data passing through. FIG. 1 shows an exemplary sequence number generator 175 coupled to DL unit 14N by way of connection 174. Normally, the sequence number generator 175 will keep sequencing through consecutive numbers so that every number in a long string of numbers is unique relative to that run. The sequence number generator 175 may rollover every so often when it hits its upper count limit. It may also reset if the port is reset. Thus the number sequence produced by the generator 175 is generally an unbroken one except when the generator is reset. (Connection 178, between generator 175 and RB controller 177, may be used in accordance with the present disclosure to control how retry data is fetched from the retry buffer 165.n as will be seen when FIG. 3 is discussed in detail.)

Shown at 115 is an exemplary data packet. The data packet typically has a header section 115a, a payload or message section 115b and an error checking and/or correcting section (ECC or CRC) 115c. Each packet may have its own unique length 115d depending on its type and size of internal payload or message 115b. It is to be understood that each of links 111-11N carries digital data packets similar to 115 except that the specific structures, lengths and/or other attributes of packets in each link may vary from application to application. (For example, some packets may not include ECC sections like 115c.) Under some communication protocols, the source device (e.g., 102) first requests access through a network pathway that includes the corresponding link (e.g., 11N), and a domain controller must first grant that request, whereupon the source device (102) can then stream a continuous sequence of packets (identified by unique sequence numbers) through the allocated network pathway; and then, when finished, the source device (e.g., 102) relinquishes use of the pathway so that other in-network devices can use the relinquished network resources. Since other devices may be waiting to use the allocated network pathway 11N, if third device 103 transmits a resend request to second device 102, it is desirable that device 102 be able to respond to that resend request as quickly as possible so as not to prolong the wait of the other devices wanting to use the same network path 11N.

Referring to the header section 115a of the illustrated packet 115, PCI-Express has some unique attributes among which is use of different types of data exchanges. Among the different exchange types there are DLL packets (DLLP's) which provide communication between the DL layers of link partners (e.g., 102-103) and TL packets (TLP's) which provide communication between the TL layers of link partners (e.g., 102-103). This is summarized in box 115e of FIG. 1. TLP's may come under different types such as those belonging to non-posted split transactions and posted transactions. The split transaction usually involves two types of TL packets: a completion TL packet (CP) and a companion non-posted TL packet (NP). The posted transaction uses a third type of TL packet identified, appropriately, as the posted transaction packet (PT). DLLP's also come in different types. One such DLLP type in the PCI-Express realm is known as a NAK DLLP and it indicates a negative acknowledgement sent at the data link layer level from the receiving link partner (e.g., due to a bad error check result at the receiver, i.e., 103) to the transmitting partner (i.e., 102). Another PCI-Express DLL packet type is the ACK DLLP which indicates a positive receipt acknowledgement from the link partner (i.e., 103). Such a positive receipt acknowledgement lets the sender know that the sender can safely remove the corresponding backup packet copy from its retry buffer. The packet type designation may be specified in the header section 115a of the PCI-Express packet or elsewhere in the packet. Often, the header 115a will identify a destination for the packet 115 (and optionally—although not true in PCI-Express 1.0—a time stamp for indicating how aged the packet may be due to it waiting for an arbiter to grant it processing time). Additionally, as already mentioned, a portion of the packet 115 will usually contain a sequence number (see 223b-223c of FIG. 2) placed there by the data link layer for indicating where in a particular stream of packets the particular packet belongs. The sequence number data may be used to reorder payload or message segments if their corresponding packets arrive out of order at a given destination. This can happen for example, if packet number 3 arrives after packet number 10 because packet number 3 had to be resent.

Referring to FIG. 2, the conventional PCI-Express packet has its sequence number located in a pre-defined position 223b-223c as is shown in the figure. The conventional sequence number is placed across two bytes, SEQ1 and SEQ2; but in one embodiment it occupies only the least significant 12 bits of those two bytes. For sake of a more complete description of the conventional PCI-Express packet 222, FIG. 2 shows the packet structure as an ingressing one that is in its post-SERDES but pre-DL format where the packet has been converted from a serial 10-bits per character, optical encoding form into 8-bits per character form but the packet is not yet stripped of physical layer code characters STP and END. Accordingly, the illustrated pre-DL ingressing packet 222 contains the following sequence of successive bytes when implemented according to the PCI-Express protocol: First, a start-of-packet (STP) synchronizing character 222a—one that has been converted from a unique optically-encoded serial format (e.g., a 10 bit optical format) that indicates start of packet into a corresponding parallel data format (e.g., 8 bits per character format). Following the STP character are: the two sequence number bytes 223b-223c intended for processing by the DL layer during ingress, and then a lead data byte (DB0) 224d intended for processing by the TL layer during ingress. This is followed by next successive data bytes (DB1-DBx) also targeted for processing by the TL layer or a deeper core 280-29-297. Immediately after the last payload byte (DBx) 224e, there is provided a succession of four cyclical redundancy check bytes (CRC3-CRCO) 223f-223i intended for processing by the DL layer during ingress, and finally an end-of-packet (END) synchronizing character 222x whose optically-encoded counterpart is intended for use by the physical layer (PL). Like the STP character, the END character was originally in optically-encoded serial format (e.g., 10 bit format) where it could be uniquely distinguished from other packet characters for locating the end of the not-yet-stripped packet structure 222 and thereafter the END character has been converted into parallel data format (e.g., 8 bits per character format) where it may no longer be uniquely distinguishable from other 8 bit encoded characters. The physical interface layer (PL) can, however, keep track of the location of the STP and/or END characters in memory as they progress through the PL layer and towards the data link layer (DL), and thus the system can keep track of where the CRC bytes and sequence number bytes are and where the payload data bytes are as the packet progresses from PHY layer to DL layer and then to the TL layer.

Scissor symbols 232a, 232b are employed in FIG. 2 in combination with a first trash can symbol 233 for schematically representing a desired first strip-off and utilize action to be applied during ingress to the STP byte 222a and to the END byte 222x by circuitry of the physical interface layer (PL). The packet receiving Phys Layer 231 uses the STP and END symbols in their optically-encoded form for delineating the start and end of the embraced, other bytes 223b through 223i in each ingressing data packet 222. FIG. 2 further schematically shows the desired use and strip-off of the SEQ1, SEQ2 bytes 223b-223c and the CRC bytes 223f-223i by the data link layer (DL) during ingress where this use is represented by means of scissor symbols 242a, 242b and the second trash can symbol 243. The remaining, post-DL packet bytes 224 are then re-aligned for use by the transaction layer (TL) column 251 so that the TL0 layer can properly process the remaining data bytes 224.

In one embodiment, after TL processing occurs (where the TL processing may include further strip off of shell bytes), the TL processed data words (e.g., bytes) may be temporarily stored in respective FIFO's which could be inserted in unit 280 of the drawing. The FIFO buffers may then feed their ingressed and stripped data (stripped to the file layer level) to the post-TL processing core 290-297. In one embodiment, the packet processing device 200 operates as a multiported switching device. In another embodiment, device 200 operates as a single port, end-leaf device within a network having multiported switches that route data to (and/or from) the end-leaf device.

For purpose of further illustration, FIG. 2 shows in this embodiment that the ingress port (Port-0) is configured as a by-8 lane aggregation and that the first serial physical link 211 includes a high frequency source amplifier 201 coupling via twisted wire pair to a corresponding receiving amplifier 221, where the latter amplifier 221 is inside IC device 200. Multiple channels of data may be transmitted over the first multiplexed serial physical link 211 by use of one or more forms of signal multiplexing. Time domain multiplexing (TDM) may be used for example, on the physical serial link 211 for mixing together the data of a number of lanes or sub-channels. In the example of multiplexed serial physical link 211 and its corresponding, first ingress port 271, system configuration operations have created an aggregation of eight lanes numbered 0-7, with each post-SERDES lane effectively constituting a one byte (1-B) wide parallel lane. Post-TL payload data passes through processing units 280, 290 and 297 for subsequent output by way of egress port 27N (Port_N). The ingress-side retry buffers are not shown in this diagram in order to avoid illustrative clutter.

The Post-DL packet data 224 may include a resend request (e.g., a DLLP NAK message) that instructs port 27N to resend a particular packet out through serial link 21N because a first send and receive attempt for that to-be-resent packet failed. In one embodiment, the resend request (inside field 224, not explicitly shown) contains part or all of the sequence number of the already-buffered, other to-be-resent packet (not the same packet as the packet 222 carrying the resend message inside field 224). Contents of the to-be-resent packet are stored in one or more retry buffer units such as 265 (RB(N)) of FIG. 2.

Referring to FIG. 3, a circuit 300 for managing the storage of, and locating and fetching of retry buffer contents in accordance with the disclosure is shown. Data link layer section 341 is understood to include a sequence number generator 375 that outputs a consecutive succession of 12 bit numbers (sequence number signals) for attachment to corresponding pre-DL egressing packets (see 224 of FIG. 2) by DL attachment means 380. The data link layer section 341 may also attach a respective error check code (see 223f-223i of FIG. 2) to each of the consecutively numbered pre-DL egressing packets. The resulting packet contents then continue along bus 381 to multiplexer 368 for output on line 369 to the physical layer. In one PCI-Express embodiment, the physical layer converts the multiplexer output 369 into optically encoded form (8B/10B) and attaches start of packet (STP 222a) and end of packet (END 222x) delimiting codes. The result is then serialized and output to the link partner via the corresponding serial link (i.e., PCI-Express lane(s))

Bus 381 also couples to the write data input port of retry buffer (RB) 365 so that resendable copies of the post-DL packet contents can be stored for a predetermined time in the RB 365. A 12-bit portion 381a of bus 381 couples to a sequence number extractor 321. In one embodiment, RB 365 can store copies of as many as the last 16 TLP-directed packets sent out via the physical layer to the TL layer of the link partner and not yet acknowledged by the link partner. (The actual amount stored may depend on the finite storage capacity of the RB 365 and on the lengths of the packets 315a-315p stored therein. If the packets are very long, then it may not be possible to store the maximum predetermined number of 16 of such resendable packets.) In response to receipt of the sequence number on line 381a, the corresponding sequence number extractor 321 extracts the least significant four bits of the 12 bit sequence number signal 381a and outputs these LSB's as an index number signal applied to an address input port 322 of index table 330. Those skilled in the art will appreciate that bus 322 (and extractor 321) will be expanded to output 5 LSB's if, for example, RB 365 is designed to store no more than the last 32 sent packets, or reduced to output just 3 LSB's if RB 365 is designed to store no more than the last 8 sent packets.

A write address sequencer 310 generates the start and further addresses at which each resendable packet contents (381) are to be stored in the RB 365. Although not shown, in one embodiment, write address sequencer 310 is responsive to a free space manager circuit within unit 335. The free space manager 335 indicates to the write address sequencer 310 where sufficient free space exists within RB 365 for storing the contents (381) of each next-to-be-stored and resendable packet. Output line 312 of the write address sequencer 310 couples to the write address input port of RB 365 and also to the data write input of index table 330. The starting write address of line 312 is recorded into a corresponding slot of the index table 330 as identified by the index signal output onto bus 322 (e.g., the 4 LSB's of the sequence number) by extractor 321. It is within the contemplation of the disclosure to use other forms of locaters in index table 330 besides storing the starting write address of line 312 directly in index table 330. For example, indirect pointers may be instead stored in index table 330.

It is seen from the above that a retry packet storing method in accordance with the present disclosure may comprise: (a) extracting a less significant part (e.g., 4 LSB's) of a sequence number (381a) of a packet whose contents are to be stored in a retry buffer for generating an index (322) into an index table (330); (b) storing the packet contents in the retry buffer (365) starting at a start address assigned to the packet by unit 310; and (c) recording the start address (or other locater) for the packet in the index table according to the generated index (322). (In one embodiment, the end address of the stored packet is also recoded in the same or a secondary index table using the same generated index (322) as part of, or the whole of, the write address applied to the index table(s)).

After the original egressing packet is sent out via line 369 and via the physical layer to the link partner (e.g., 103 of FIG. 1), it is expected that the link partner will send back an acknowledgement packet 315Q to the sender within a predefined time limit established by a timer 316c. There are at least 3 possibilities: (a) the link partner sends back a positive acknowledgement (Ack=True in box 316a) indicating good receipt; (b) the link partner sends a negative acknowledgement (e.g., a NAK DLLP packet) indicating failure of error check at the data link level (Ack=False in box 316a and/or Type=NAK DLLP); and (c) no acknowledgement indication comes back as is indicated by phantom representation 316b and the timer counts past its programmed limit value.

Consider first the case (b) where the link partner (e.g., 103) sends back a NAK DLLP indication (Ack=False) 316a. The NAK DLLP signal includes a field 316d containing the sequence number of the earlier sent, payload-carrying packet that failed error checking in the DL layer of the receiving link partner (e.g., 103). Line 317a carries that sequence number signal to a validator 318. In one embodiment, sequence numbers of NAK DLLP's or ACK DLLP's are deemed valid if they fall in a range defined by the sequence number in field 316d of the last received Ack or NAK and the sequence number (obtained from line 381a) of the last sent, packet, inclusively. Register 319a stores the sequence number of the last received Ack or NAK. Register 319b stores the sequence number of the last sent packet. Registers 319a and 319b couple to validator 318. If the NAK DLLP sequence number of line 317a falls in the valid range, it is supplied via line 320 to the extractor 321 and the corresponding 4 LSB's are output on line 322 for application to the index table. If the NAK DLLP sequence number of line 317a falls outside the valid range, it is ignored. The index table does not output a corresponding fetch address. On the other hand, if the system 300 receives a NAK DLLP indication with a valid sequence number, the index table 330 responsively outputs the starting or fetch-begin address for the corresponding and to-be-resent packet on data-out line 333. The read address sequencer and free space management unit 335 initiates to the fetch-begin address and supplies a corresponding consecutive sequence of read addresses over line 337 to the read address input port of RB 365. The retry buffer 365 then outputs the corresponding packet data via line 367 and through multiplexer 368 for processing by the physical layer. The NA[c]Ked packet is thereby resent to the link partner.

It is seen from the above that a retry packet locating and fetching method in accordance with the present disclosure may comprise: (a) using at least part of a sequence number (316d, 320) of a packet to be fetched from a retry buffer for generating an index (322) into an index table; (b) obtaining a fetch address (333) or other locater for the to-be-fetched packet from the index table according to the generated index; and (c) fetching the packet (367) from the retry buffer according to the fetch address (or other locater) obtained from the index table. In one embodiment, the end address of the to-be-fetched packet is also obtained by use of the generated index (322) as applied to the same index table or to a secondary index table (not shown).

Consider next the case (c) where the link partner (e.g., 103) does not send back either a NAK DLLP or an ACK DLLP (Ack=True in 316a) and the timer 316c flags a time limit error via line 317c. In response, the validator fetches the sequence number of the last sent packet from register 319b and applies it via line 320 to the extractor 321. The 4 LSB index signal is consequently applied via line 322 to the index table and the fetch-begin address (or other locater) for the corresponding resendable packet is generated on data-out line 333 of the index table. The read address sequencer and free space management unit 335 initiates to that fetch-begin address and supplies a corresponding consecutive sequence of read addresses over line 337 to the read address input port of RB 365. The retry buffer 365 then outputs the corresponding packet data via line 367 and through multiplexer 368 for processing by the physical layer.

Consider next the case (a) where the link partner (e.g., 103) sends back an ACK DLLP (Ack=True in 316a). In this case, the link partner successfully received the corresponding payload or message-carrying packet and it is desirable to free up the space of the corresponding backup copy from the RB 365. Line 317a carries that sequence number signal from field 316d of the ACK packet to the validator 318. If valid, the sequence number signal from field 316d continues via line 320 into the extractor 321. In response to an ACK indication and a valid sequence number in field 316d, the read address sequencer and free-space management unit 335 initiates to the fetch-begin address and scans through to the end of the packet copy, designating that region of the RB 365 as free space. New packet content (381) can then be written into that free space. The end of packet copy may be designated by a variety including use of a special delimiter code or use of the secondary index table (not shown) which stores indexed, end of packet addresses or other locaters.

It is seen from the above that a retry buffer managing system 300 is disclosed which uses a less significant subset of the sequence number for responding to NAK's, to ACK's or to timer error flags for obtaining the fetch begin address (or other locater) of the corresponding packet contents (e.g., 315a-315p) in the retry buffer 365. The retry buffer managing system 300 may include one or more index tables (e.g., 330) that are operatively coupled to a read address sequencer (335) of the retry buffer 365. The managing system 300 may further include an extractor 321 that extracts the less significant subset from a sequence number signal (381a or 320) supplied to the extractor during writing of packet contents (381) into the RB or during reading out of packet contents (367) from the RB 365 or during establishment of new free space in the RB 365. In one embodiment, the extractor 321 couples to a sequence number validator 318 that validates externally-supplied sequence numbers as belonging to an expected range of sequence numbers (319a-319b).

The present disclosure is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, use of equivalent functional couplings for couplings described herein, and/or use of equivalent functional steps for steps described herein. Such insubstantial variations are to be considered within the scope of what is contemplated here. Moreover, if plural examples are given for specific means, or steps, and extrapolation between and/or beyond such given examples is obvious in view of the present disclosure, then the disclosure is to be deemed as effectively disclosing and thus covering at least such extrapolations.

By way of a further example, it is understood that other arrangements besides use of a single address input (322) into the index table may be used. The index table may have separate address input ports for read and write purposes. Alternatively or additionally, where separate read versus write ports are shown for memory data and address signals, memory units may be used where these are provided by multiplexed ports and use of read-enable and write enable signals for designating type of operation. Although index table 330 is shown to use the index signal 322 as a direct address input, it is within the contemplation of the disclosure to use a CAM style memory (content addressable memory) for the index table where the index number is stored as part of the memory content.
Reservation of Extra-Patent Rights, Resolution of Conflicts, and Interpretation of Terms

After this disclosure is lawfully published, the owner of the present patent application has no objection to the reproduction by others of textual and graphic materials contained herein provided such reproduction is for the limited purpose of understanding the present disclosure of invention and of thereby promoting the useful arts and sciences. The owner does not however disclaim any other rights that may be lawfully associated with the disclosed materials, including but not limited to, copyrights in any computer program listings or art works or other works provided herein, and to trademark or trade dress rights that may be associated with coined terms or art works provided herein and to other otherwise-protectable subject matter included herein or otherwise derivable herefrom.

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

Unless expressly stated otherwise herein, ordinary terms have their corresponding ordinary meanings within the respective contexts of their presentations, and ordinary terms of art have their corresponding regular meanings within the relevant technical arts and within the respective contexts of their presentations herein.

Given the above disclosure of general concepts and specific embodiments, the scope of protection sought is to be defined by the claims appended hereto. The issued claims are not to be taken as limiting Applicant's right to claim disclosed, but not yet literally claimed subject matter by way of one or more further applications including those filed pursuant to 35 U.S.C. §120 and/or 35 U.S.C. §251.

What is claimed is:

1. A retry packet storing method comprising:
(a) using a less significant portion of a sequence number of a packet to be stored in a retry buffer for generating an index referencing a first location of a first index table;
(b) storing the packet in the retry buffer at a start address assigned to the packet; and
(c) recording the start address or other locater for the packet in the first location of the first index table such that the start address or other locater is retrievable from the first index table by using the generated index as a reference to the first location.

2. The retry packet storing method of claim 1 and further comprising:
(d) recording an end address for the packet in a second location of a second index table, such that the end address is retrievable from the second index table by using the generated index as a reference to the second location.

3. The retry packet storing method of claim 1 wherein:
(a.1) said less significant portion consists of a least significant 5 bits of the sequence number.

4. The retry packet storing method of claim 1 wherein:
(a.1) said less significant portion consists of a least significant 4 bits of the sequence number.

5. The retry packet storing method of claim 1 wherein:
(a.1) said less significant portion consists of a least significant 3 bits of the sequence number.

6. The retry packet storing method of claim 1 wherein:
(a.1) said packet is formatted in accordance with a PCI-Express protocol.

7. The retry packet storing method of claim 1 wherein:
(b.1) said start address is assigned to the packet by a free space managing unit that allocates free space of the retry buffer for writing into that free space.

8. The retry packet storing method of claim 1 wherein:
(c.1) said retrieval of the start address or other locater uses the generated index as a direct part of a read address signal applied to the first index table to reference the first location.

9. The retry packet storing method of claim 1 wherein:
(c.1) said retrieval of the start address or other locater uses the generated index as part of a content addressable query applied to a content addressing input of the first index table to thereby reference the first location.

10. A retry packet locating and fetching method comprising:
(a) using at less significant portion of a sequence number of a packet to be fetched from a retry buffer for generating an index referencing a first location an index table;
(b) obtaining a fetch address or other locater for the to-be-fetched packet from the first location of the index table; and
(c) fetching the packet from the retry buffer according to the fetch address or other locater obtained from the first location of the index table.

11. The retry packet fetching method of claim 10 and further comprising:
(d) obtaining an end address for the to-be-fetched packet from a second location in the same index table or in a second index table, where the second location is referenced by the generated index.

12. The retry packet fetching method of claim 10 wherein:
(a.1) said less significant portion consists of a least significant 5 bits of the sequence number.

13. The retry packet fetching method of claim 10 wherein:
(a.1) said less significant portion consists of a least significant 4 bits of the sequence number.

14. The retry packet fetching method of claim 10 wherein:
(a.1) said less significant portion consists of a least significant 3 bits of the sequence number.

15. The retry packet fetching method of claim 10 wherein:
(a.1) said to-be-fetched packet is formatted in accordance with a PCI-Express protocol.

16. The retry packet fetching method of claim 10 and further comprising:
(d) applying said start address to read sequencer that sequences through plural locations of the retry buffer for reading from those plural locations.

17. The retry packet fetching method of claim 10 wherein:
(b. 1) said obtaining of the fetch address or other locater uses the generated index as a direct part of a read address signal applied to the first index table to reference the first location.

18. The retry packet storing method of claim 1 wherein:
(b.1) said obtaining of the fetch address or other locater uses the generated index as part of a content addressable query applied to a content addressing input of the first index table to thereby reference the first location.

19. A retry buffer managing system comprising:
(a) a retry buffer;
(b) an index table for storing locaters of to-be-located and fetched packets that are stored in the retry buffer; and
(c) an index generator coupled to the index table for generating indexes referencing locaters in the index table, where the index generator is at least responsive to sequence numbers associated with packets to be stored in and later located and fetched from the retry buffer;
(a.1) wherein the retry buffer is operatively coupled to the index table so as to receive fetch start addresses derived from locaters of the index table where the locaters are stored in the index table according to said indexes generated by the index generator.

20. The retry buffer managing system of claim 19 and further comprising:
(d) a validity checker for testing validity of sequence numbers directed to the index generator when such applied sequence numbers are to be used for locating and fetching packets from the retry buffer.

21. The retry buffer managing system of claim 20 wherein the validity checker includes means for determining whether a supplied sequence number is in a range between a first sequence number provided in a last-received acknowledgment message and a second sequence number provided in a last-sent and to-be-acknowledged packet.

22. The retry buffer managing system of claim 20 wherein the validity checker causes invalid sequence numbers to be ignored by the index generator.

23. The retry buffer managing system of claim 20 and further comprising:
(e) a timer for detecting if a last-sent and to-be-acknowledged packet has not been acknowledged within a predefined time limit, the timer being operatively coupled to the index generator for causing the index generator to generate an index referencing the locater of the last-sent and to-be-acknowledged packet so that the last-sent and to-be-acknowledged packet is automatically resent from the retry buffer after said predefined time limit has lapsed.

24. The retry buffer managing system of claim 19 and further comprising:
(d) an acknowledgement detector operatively coupled to the index generator for causing the index generator to generate an index referencing the locater of a sent and acknowledged packet so that storage space for the sent and acknowledged packet can be reallocated as free space within the retry buffer after said sent and acknowledged packet is acknowledged.

25. A data resending system for saving copies of sent packets and resending a respective packet copy if receipt of the corresponding sent packet is not timely acknowledged, the resending system comprising:
(a) an index table for storing locaters of to-be-located and resent packet copies; and
(b) an index generator coupled to the index table for generating indexes referencing locaters in the index table, where the index generator is at least responsive to sequence numbers associated with the sent packets;
(a.1) wherein fetch start addresses for fetching and resending the respective packet copies that are to be resent are derived from the locaters of the index table and the locaters are obtained from the index table according to said indexes generated by the index generator.
